(19) United States
(12) Patent Application Publication
(10) Pub. No.: US 2005/0000203 A1
(43) Pub. Date: Jan. 6, 2005

(54) Axially expandable roller for turf mowing equipment

(76) Inventors: Donald L. Rogers, Tucson, AZ (US); Thomas W. Rogers, Tucson, AZ (US)

Correspondence Address: QUARLES & BRADY STREICH LANG, LLP, ONE SOUTH CHURCH AVENUE, SUITE 1700, TUCSON, AZ, 85701-1621, US

(21) Appl. No.: 10/613,688

(22) Filed: Jul. 3, 2003

(51) Int. Cl. A01D 34/64

(52) U.S. Cl. 56/16.7

(57) ABSTRACT

A roller for turf mowing equipment utilizes an interlocking connection with a gap between roller sections and a resilient sleeve to protect the connection. The gap between adjacent sections accommodates thermal expansion, thereby preventing binding and roller failure. The resilient sleeve prevents infiltration of contaminants through the gap. In addition, the resilient sleeve fits tightly between the roller sections urging them apart to maintain the gap and a uniform section distribution during use.

### BACKGROUND OF THE INVENTION

1. Field of Invention

The present invention generally relates to ground-contacting rollers commonly used on turf mowing equipment for golf courses and other places where precise cutting is required. More particularly, the invention relates to a roller that utilizes a resilient sleeve over a gap between adjacent sections of the roller to accommodate thermal expansion and to prevent roller contamination.

2. Description of Prior Art

Turf mowing equipment used for golf courses utilizes ground-contacting rollers to cut grass to a desired height. The rollers rotate along a metal shaft attached to the mower assembly. As the mower blade cuts the grass, the rollers roll along the ground and hold the mower assembly above the grass.

Rollers come in solid and grooved versions and are typically made of metal, such as aluminum and stainless steel, or of a plastic material such as nylon, MDS nylon, oil-filled nylon, and preferably ultra-high molecular weight (UHMW) polyethylene plastic. This plastic material is beneficial because it does not harm sprinkler heads or yardage markers as a metal roller would. Because of manufacturing limitations, plastic-material rollers are usually divided into multiple sections that are combined to make a mowing roller of desired length. Bearings and washers or end caps are typically used to hold the sections in place at each end.

Some problems tend to develop as these types of rollers are utilized over time. Because each roller consists of multiple sections, non-uniform ground conditions may cause the sections to spin against one another and not move as one piece. This causes friction between sections that will result in roller failure and prevent the turf mower from moving efficiently. In addition, grass and/or dirt can contaminate the roller by infiltrating the gaps where the sections meet. This contamination hinders the roller's ability to rotate around the metal shaft and again may cause adjacent sections to spin against each other.

Another problem with this roller design lies in the fact that plastic material is subject to expansion with increasing operating temperatures, especially when subject to the additional friction caused by uneven rotation. As a result, the connection between roller sections becomes too tight for the roller to rotate freely around the metal shaft, which also may cause roller failure.

Accordingly, there is still a need in the art for a multi-section roller with connections that prevent infiltration of contaminants and accommodate thermal expansion between sections.

### BRIEF SUMMARY OF THE INVENTION

The present invention provides a ground-contacting roller for turf mowers consisting of multiple sections coupled to form a unit over a single axle. The roller sections are rigidly connected so as to prevent them from spinning against one another and each connector is protected to prevent contaminants from infiltrating the roller. In addition, the connector design accommodates thermal expansion of the roller sections during elevated operating temperatures.

The invention applies equally to any conventional form of roller, such as flat rollers (referred to in the art as “solid”) and grooved rollers. In general terms, the invention utilizes a connection with an axial gap covered by a resilient sleeve pressing against adjacent roller sections. According to one aspect of the invention, the gap in the connection is provided to accommodate for thermal expansion. Thus, as the plastic sections expand with increasing operating temperatures, the gap between roller sections decreases to conform to the expansion and avoid roller failure.

On the other hand, the gap between sections allows infiltration of contaminants to produce friction between roller sections and against the shaft. Thus, according to another aspect of the invention, a resilient sleeve is fitted tightly pressing against each pair of roller sections to cover the gap in the connection. Thus, dirt, grass and other debris cannot penetrate the gaps and affect the function of the roller.

Because of their resilience, the sleeves allow the roller to expand and contract and, at the same time, maintain a tight seal that prevents detrimental axial movement of the sections and precludes contamination under all conditions. Accordingly, the sleeves are selected to be slightly wider than the width of the section connectors. Thus, the sections are urged away from each other and the gap between them is maintained while the sections remain tightly coupled and uniformly distributed along the axle and against the supports at the ends of the roller.

### BRIEF DESCRIPTION OF THE DRAWINGS

FIG. 1 is a perspective, partially cut out, view of a roller according to the invention shown attached to the supports of a mower assembly.

FIG. 1A is an elevational view of a grooved roller according to the invention.

FIG. 2 is an exploded partial view of the roller of FIG. 1 showing the resilient sleeve and interlocking section connectors.

FIG. 3 is a front elevational view of the roller showing the two sections coupled by interlocking connectors.

FIG. 4 is a front elevational view of the roller with the two section connectors covered by a resilient sleeve according to the invention.

FIG. 5 is an exploded view of an alternative embodiment of the invention utilizing a non-interlocking connection.

### DESCRIPTION OF THE PREFERRED EMBODIMENTS OF THE INVENTION

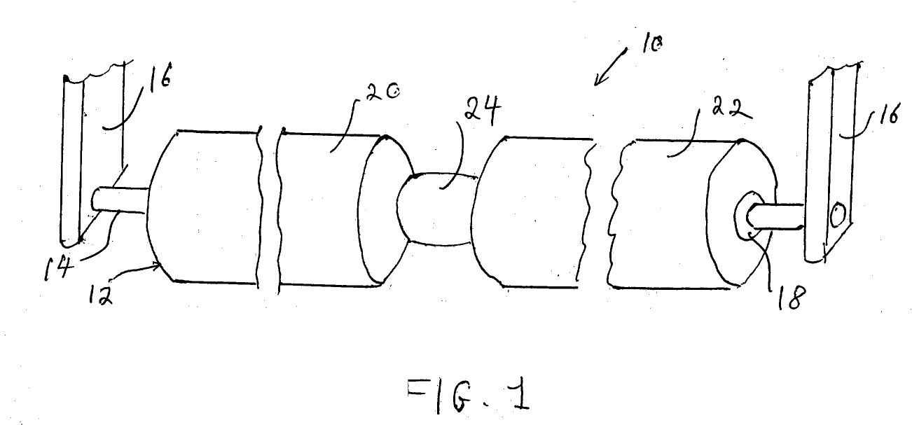

Referring to the drawings, FIG. 1 shows a mowing roller assembly 10 according to the preferred embodiment of the invention. The roller assembly 10 includes a roller 12 rotatably mounted to a metal shaft or axle 14 coupled to mowing equipment by means of suitable supports 16. At each end of the roller 12, lubricated bearings 18 with corrresponging nuts (not shown) hold the roller in place on the axle 14 and allow the roller to rotate freely and avoid heat due to friction.

The roller 12 shown in FIG. 1 consists of two cylindrical sections 20,22, but it is understood that the roller may consist of an unlimited number of sections of a variety of shapes, including a grooved rolling surface, as illustrated in FIG. 1A. The individual sections are preferably formed of a solid plastic material, in particular an ultra-high molecular weight (UHMW) polyethylene plastic because of its toughness, wear characteristics, natural cleaning capabilities, and its frictionless bearing properties. The sections 20,22 are joined through. interlocking, keyed connectors (not seen in FIG. 1) covered by a rubbery sleeve 24. This sleeve is made of a flexible and resilient material, such as rubber or neoprene, that fits firmly pressed against the two sections. Preferably, the sleeve 24 is made of neoprene, which is particularly suitable for its durability and resilience over a wide range of operating temperatures and for its resistance to degradation from fertilizers and other chemicals to which these rollers are normally subjected.

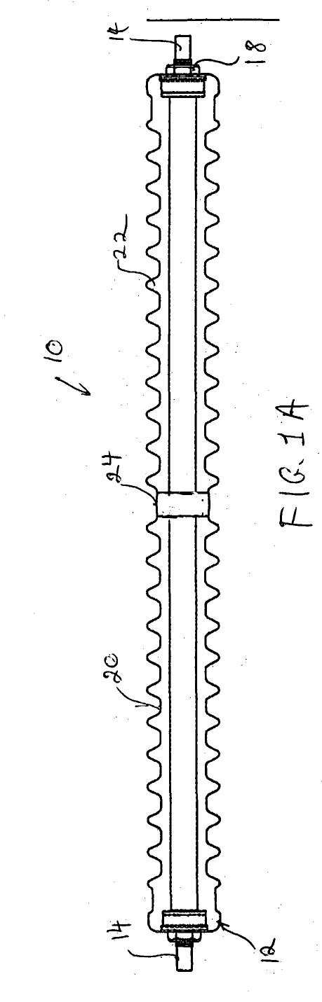

FIG. 2 is an exploded partial view of the roller 12 and the resilient sleeve 24 of FIG. 1. The joinable ends of the roller sections 20,22 include interlocking connectors that consist of cylindrical protrusions 26 with axial grooves 28 and fingers 30 suitable for meshing in keyed arrangement with corresponding opposite grooves and fingers in adjacent connectors. The resilient sleeve 24 is used to cover the connectors 26 of joined sections, thereby protecting the interlocking finger/groove connection. If more than two sections make up one roller, each pair of adjacent sections is coupled in similar fashion using interlocking connectors 26 at each end thereof.

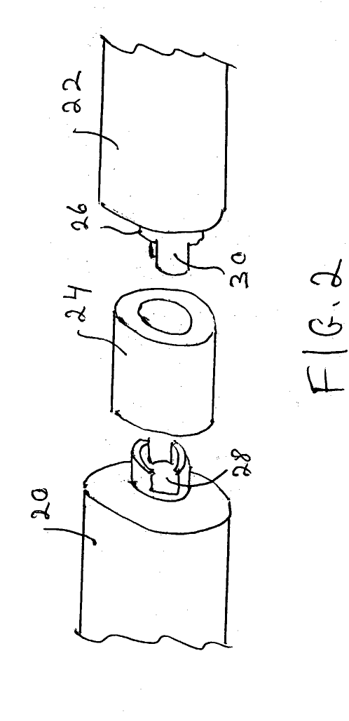

FIG. 3 illustrates the roller 12 with the two sections 20,22 coupled as described, but without the resilient sleeve 24. The fingers 30 in the cylindrical end 26 of each interlocking connector mesh into the grooves 28 of the adjacent connector, locking the two sections together. The locked connection prevents one section from spinning against the other and the roller 12 rotates as one piece. By providing a gap 32 in the groove/finger connection of the interlocking connectors, thermal expansion of the roller sections can be accommodated, thereby preventing binding of the roller as a result of friction or environmental heat. A gap of about 0.125 inches was found to be suitable to accommodate the maximum predictable expansion of a typical UHMW 18-inch roller section.

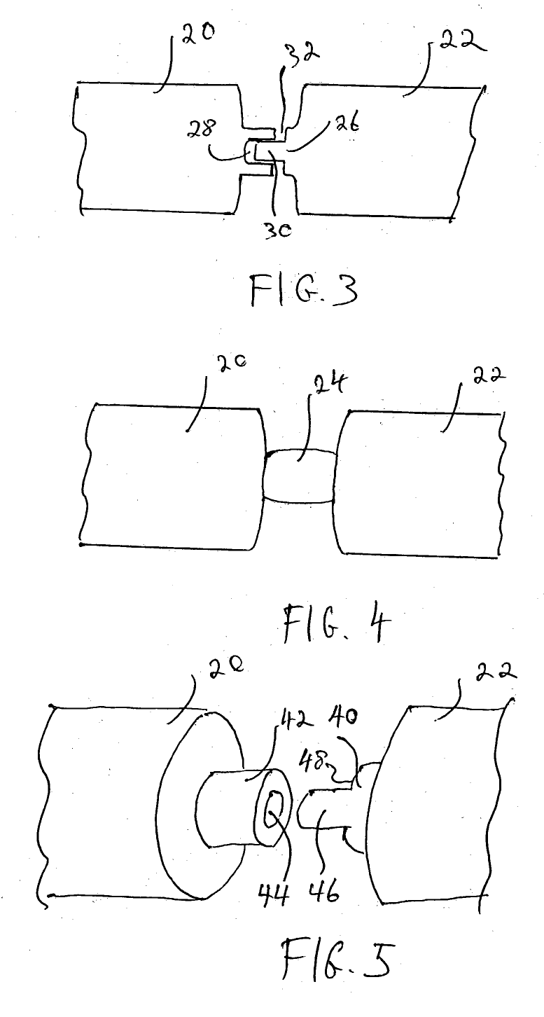

To prevent contaminants from infiltrating the gap 32 and causing additional friction between the roller 12 and the axle 14, the resilient sleeve 24 is slipped over the connectors 26 between roller sections, as shown in FIG. 4. In use, the resilient sleeve is partially compressed between roller sections and remains firm between them while the roller is in operation, thereby tightly shielding the gaps in the interlocking connectors. By urging adjacent sections apart, in addition to preventing contamination, the resilient sleeve 24 prevents play and maintains a uniform distribution of the roller sections along the axle 14 under varied thermal-expansion conditions.

In the preferred embodiments of the invention, the roller 12 consists of two sections approximately 2-3.5 inches in diameter and 9-16 inches long, each with a connector at a single end. Each connector consists of a protrusion 26 about 0.5 inches long with a pair of fingers 30 about 0.345 inches long defining commensurate grooves 28 adapted to mate with each other. The other ends of the roller sections are sealed by a support bearing 18 mounted on an axle 14, which is adapted for installation in a mower. The main purpose of the bearings is to accommodate the preload from the resilient sleeve required to seal the connections between sections and the end-thrust loads exerted on the rollers by uneven operating terrain.

An alternative embodiment of the invention utilizes a non-interlocking connection that allows a limited amount of slippage and spin between adjoining sections, which may be desirable for mowing terrains with non-uniform surfaces. FIG. 5 illustrates the ends of abutting roller sections with such non-interlocking connectors 40 adapted to support the resilient sleeve 24. As in the case of the embodiment with interlocking connections, a gap is maintained between the ends of the connectors 40 accommodate thermal expansion, and a resilient sleeve is similarly placed over the connection to prevent contamination. It is noted that a groove in the end of each roller section could be used in equivalent manner, instead of the connectors 40, to hold the sleeve 24 in place. Similarly, the invention could be practiced simply by using a compressed sleeve 24 covering a gap between adjacent roller sections even without the support provided by connectors 40 or grooves in the bodies of the rollers.

Therefore, while the present invention has been shown and described herein in what is believed to be the most practical and preferred embodiments, it is recognized that departures can be made therefrom within the scope of the invention, which is not to be limited to the details disclosed herein but is to be accorded the full scope of the claims so as to embrace any and all equivalent apparatus and processes. For example, the sleeve 24 could be manufactured in a material that is not necessarily resilient and is wrapped around or incorporates a spring coil. In such case, the compressed coil between adjacent roller sections would provide the required resilience to the-sleeve of the invention. Accordingly, the term resilient sleeve, as used herein, is intended to refer to any structure capable of sealing a gap between adjacent roller sections while also urging them apart.

1. An improved mowing-equipment roller with a plurality of roller sections having end connectors for coupling adjacent roller sections, wherein the improvement comprises a gap in said end connectors and a resilient sleeve covering said gap and urging said adjacent roller sections apart.

2. The roller of claim 1, wherein said end connectors consist of interlocking connectors.

3. The roller of claim 2, wherein said interlocking connectors include mating fingers and grooves.

4. The roller of claim 3, wherein said gap is between said mating fingers and grooves of the interlocking connectors.

5. The roller of claim 1, wherein said end connectors consist of sidable connectors.

6. The roller of claim 5, wherein said slidable connectors include support members for the resilient sleeve.

7. The roller of claim 6, wherein said gap is between said support members.

8. A method for preventing binding caused by thermal expansion in a mowing-equipment roller having a plurality of roller sections and end connectors for coupling adjacent roller sections, comprising the following steps:
providing a gap in said end connectors and a resilient sleeve covering said gap and urging said adjacent sections apart.

9. The method of claim 8, wherein said end connectors consist of interlocking connectors.

10. The method of claim 9, wherein said interlocking connectors include mating fingers and grooves.

11. The method of claim 10, wherein said gap is between said mating fingers and grooves of the interlocking connectors.

12. The method of claim 8, wherein said end connectors consist of slidable connectors.

13. The method of claim 12, wherein said slidable connectors include support members for the resilient sleeve.

14. The method of claim 6, wherein said gap is between said support members.
